(19) United States
(12) Patent Application Publication
(10) Pub. No.: US 2020/0148131 A1
(43) Pub. Date: May 14, 2020

(54) MODULAR TABLET COMPUTER AND VEHICLE DIAGNOSTIC ELECTRONIC SYSTEM

(71) Applicant: THINKCAR TECH CO., LTD., SHENZHEN (CN)

(72) Inventor: Bin Tan, Sanhe (CN)

(73) Assignee: THINKCAR TECH CO., LTD.

(21) Appl. No.: 16/742,874

(22) Filed: Jan. 14, 2020

(51) Int. Cl. B60R 11/02; G07C 5/08

(52) U.S. Cl. CPC B60R 11/0252; G07C 5/0808; G07C 5/0825

(57) ABSTRACT

The present invention discloses a modular tablet computer and a vehicle diagnostic electronic system. The modular tablet computer comprises a shell, a display screen, a module expansion slot, a main board and a communication interface, wherein the shell has an opposite first board and a second board, as well as an opposite first side and a second side. The display screen is located on the first board of the shell and connected with the shell in a snap-fit manner. The module expansion slot is arranged on the second board, the first side or the second side of the shell and connected with a vehicle diagnostic electronic device in the snap-fit manner. The main board is electrically connected with the display screen and arranged in the shell. A first signal part is connected with a second signal part of the vehicle diagnostic electronic device.

### TECHNICAL FIELD

The present invention belongs to the field of vehicle inspection equipment, and specifically provides a modular tablet computer and a vehicle diagnostic electronic system.

### BACKGROUND

Currently, parts and operation states of a vehicle are inspected in various aspects, such as infrared thermography, battery test and the like. Specifically, a thermographic comparison diagram of a certain object can be obtained by using a thermographic instrument to take a picture, putting the picture in an electronic device to compare; battery inspection needs a battery tester; the other inspections need corresponding inspection devices. Therefore, vehicle inspection needs various inspection devices, which are inconvenient to operate. Furthermore, when an inspection result in an electronic device needs to be checked out, most of the time it needs to be printed through a result output device such as a printer to assist to check out. At this time, a printing document or a picture needs to be copied into a computer, and then the computer is connected with a standard printer to print the document or the picture. If other functions are required, the electronic device needs to be connected with other, devices through connecting lines to process. In conclusion, various inspection devices and a result output device are involved in vehicle inspection, and during a full range of inspection, methods of using, the various devices are tedious and different from each other.

### SUMMARY

To overcome disadvantages of the prior art, the present invention provides a modular tablet computer. The modular tablet computer is configured to solve a technical problem, that multiple devices are complex to operate during vehicle inspection.

To solve such technical problem, the present invention adopts the following technical solution: a modular tablet computer is provided, comprising:

a shell, having an opposite first board and a second board, as well as an opposite first side and a second side;

a display screen, located on the first board of the shell and connected with the shell in a snap-fit manner;

a module expansion slot, arranged on the second board, the first side or the second side of the shell and connected with a vehicle diagnostic electronic device in the snap-fit manner;

a main board, electrically connected with the display screen and arranged in the shell; and

a first signal part, connected with a second signal part of the vehicle diagnostic electronic device.

In an embodiment, the first signal part is a communication interface, is electrically connected with the main board and is arranged on the module expansion, slot; when the module expansion slot is connected with the vehicle diagnostic electronic device in the snap-fit manner, the main board and a communication interface of the vehicle diagnostic electronic device are connected through the communication interface.

In an embodiment, the modular tablet computer further comprises multiple mounting holes, which are arranged on the module expansion slot.

In an embodiment, there are four mounting holes, namely a first mounting hole, a second mounting hole, a third mounting hole and a fourth mounting hole; an opposite third side and a fourth side as well as an opposite fifth side and a sixth side are formed when the module expansion slot is sunken in the second board of the shell; the first mounting hole and the second mounting hole are respectively arranged on the third side and the fourth side; the third mounting hole and the fourth mounting hole are arranged on the fifth side.

In an embodiment, the first mounting hole and the second mounting hole are movable, mounting holes while the third mounting hole and the fourth mounting hole are fixed mounting holes.

In an embodiment, the modular tablet computer further comprises a first slide rail passing through the first mounting hole and a second slide rail passing through the second mounting hole, wherein the opposite third side and the fourth side are formed when the module expansion slot is sunken in, the second board of the shell; the first slide rail is located on, the third side and is parallel with the second board, and the second slide rail is located on the fourth side and is parallel with the second board.

In an embodiment, the modular tablet computer further comprises a third slide rail and a fourth slide rail, wherein the opposite third side and the fourth side are formed when the module expansion slot is sunken in the second board of the shell; the first slide rail is located on the third side and is vertical to the second board, and the second slide rail is located on the fourth side and is vertical to the second board.

In an embodiment, the modular tablet computer further comprises an aviation plug female connector, which is arranged at a handheld end on the first side and is used for connecting an aviation plug male connector of an extension line.

In an embodiment, the shell further comprises the handheld end, which is mounted on the second board of the shell, and is adjacent to the module expansion slot on the second board.

In an embodiment, the modular tablet computer further comprises a button module, power button, a camera button and a camera, all of which are mounted on the shell;

the button module is electrically connected with the main board and is used for inputting control signals to control the vehicle diagnostic electronic device and control the display screen to display the diagnostic content.

The present invention further provides a vehicle diagnostic electronic system. The vehicle diagnostic electronic system comprises at least one vehicle diagnostic electronic device, a signal transmission line and a modular tablet computer; the vehicle diagnostic electronic device is mounted on the shell of the modular tablet computer in a snap-fit manner; the first signal part of the modular tablet computer is communicated with the second signal part of the vehicle diagnostic electronic device.

In an embodiment, the vehicle diagnostic electronic device comprises a first movable snap-fit joint, a second movable snap-fit joint, a snap-fit joint button as well as an opposite first side face and a second side face; the snap-fit joint button is mounted on the vehicle diagnostic electronic device; a first telescoping hole for mounting the first movable snap-fit joint is formed in the first side face; a second telescoping hole for mounting the second movable snap-fit joint, is formed in the second side face.

In an embodiment, the vehicle diagnostic electronic device further comprises a first fixed snap-fit joint, a second fixed snap-fit joint and a third side face vertical to the first side face and the second side face; the first fixed snap-fit joint and the second fixed snap-fit joint are arranged on the third side face; when the vehicle diagnostic electronic device is connected with the shell in the snap-fit manner, the first fixed snap-fit joint and the second fixed snap-fit joint are respectively in snap fit with the third mounting hole and the fourth mounting hole of the modular tablet computer.

In an embodiment, the vehicle diagnostic electronic device comprises an opposite mounting side face and a nonslip side face; the mounting side face is close to the module expansion slot of the modular tablet computer when the module expansion slot of the modular tablet computer is connected with the vehicle diagnostic electronic device in the snap-fit manner; the nonslip side face is further provided with nonslip lines and snap-fit direction indication arrows.

In an embodiment, the vehicle diagnostic electronic device is any element selected from a group including a thermographic instrument, a lamp panel, a printer, an oscilloscope, an endoscope, a battery tester, a sensor tester and a projector.

In an embodiment, the vehicle diagnostic electronic device further comprises a communication interface; when the vehicle diagnostic electronic device is the thermographic instrument, the thermographic instrument is square-shaped; the thermographic instrument is provided with a thermal imaging camera; the thermal imaging camera and the communication interface are located on two reverse surfaces.

The beneficial effects of the present invention are as follows:

The present invention combines the modular tablet computer with the vehicle diagnostic electronic device such as a thermographic instrument in a modularization manner. When an inspection function is required, a corresponding vehicle diagnostic electronic device is mounted, and such vehicle diagnostic electronic device can be controlled by the main board, which is simpler in comparison with the prior art that an inspection device and a result output device are directly respectively used for inspecting an automobile and outputting an inspection result through connecting lines. Additionally, other different functions of the vehicle diagnostic electronic devices can be changed. Therefore, the present invention has great usability and intelligent perception effect, and has relatively low costs and high performance cost in comparison with single purchase of the inspection device and the result output device.

### BRIEF DESCRIPTION OF THE DRAWINGS

The present invention is further described below with reference to the accompanying drawings.

FIG. 1 is a front view of a modular tablet computer in the present invention.

FIG. 2 is a back view of a modular tablet computer in the present invention.

FIG. 3 is a lateral top view of a modular tablet computer in the present invention.

FIG. 4 is a lateral bottom view of a modular tablet computer in the present invention.

FIG. 5 is a front view of a vehicle diagnostic electronic device facing a shell in, the present invention.

FIG. 6 is a lateral top view of a vehicle diagnostic electronic device in the present invention.

FIG. 7 is a back view of a vehicle diagnostic electronic device facing a user in the present invention.

FIG. 8 is a top view of a vehicle diagnostic electronic device in an embodiment of the present invention.

### DESCRIPTION OF THE EMBODIMENTS

To make technical means, creation features, objectives, and effects of the present invention clearer and more comprehensible, the present invention is further described below with reference to the specific embodiments.

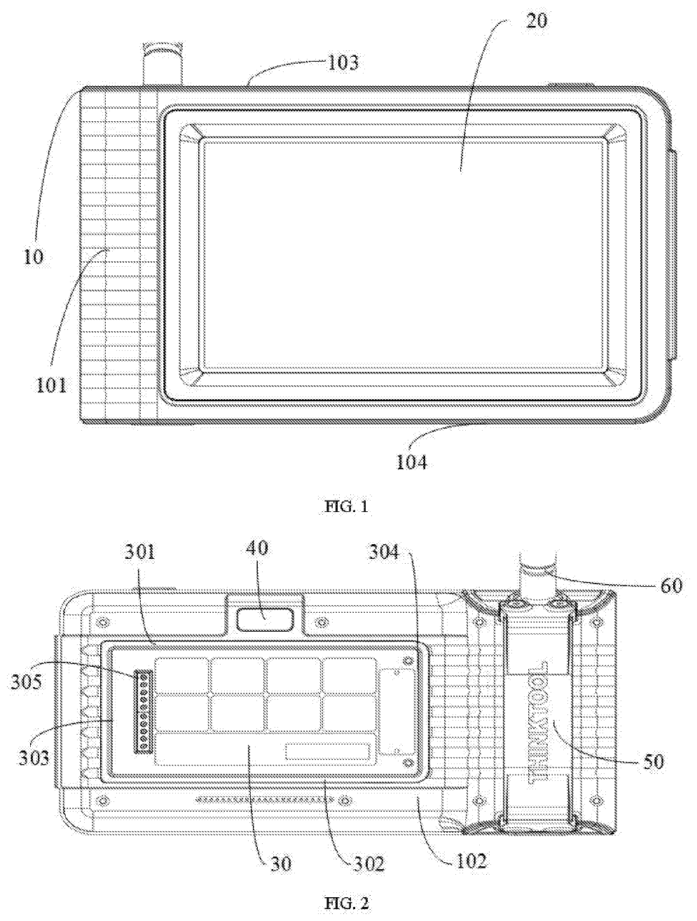

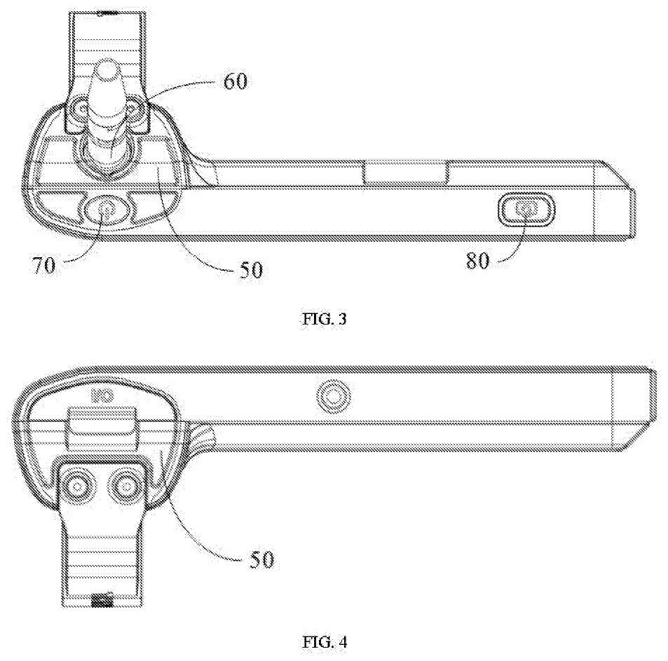

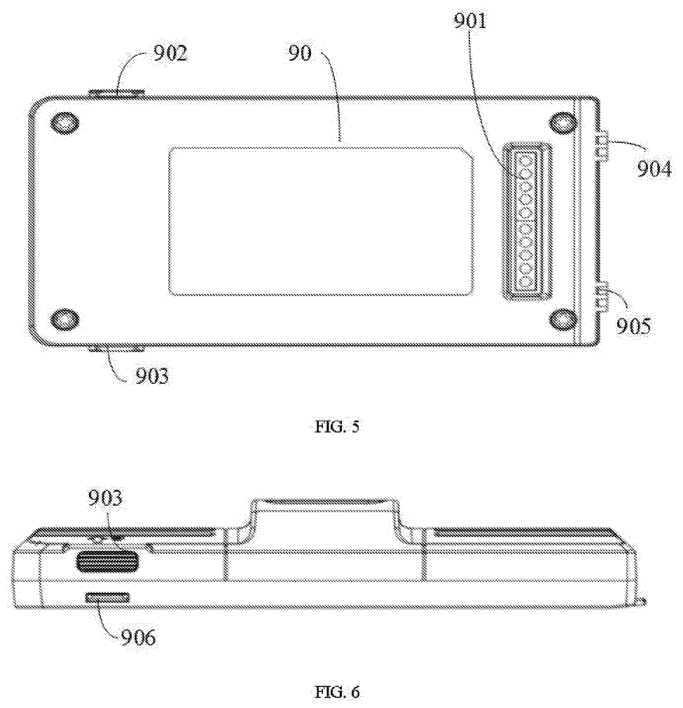

As shown in FIG. 1, FIG. 2 and FIG. 5, the present invention discloses a modular tablet computer. The modular tablet computer comprises a shell 10, a display screen 20, a module expansion slot 30, a main board and a first signal part. The shell 10 has an opposite first board 101 and a second board 102, as well as an opposite first side 103 and a second side 104. The display screen 20 is located on the first board 101 of the shell 10 in a snap-fit manner and is electrically connected with the main board. The display screen 20 can display the type, the working state and inspection results of a connected vehicle diagnostic electronic device 90. The main board is electrically connected with the display screen 20 and is arranged in the shell 10. The main board can be preinstalled with a certain existing infrared imaging software and other inspection result analysis software to conveniently analyse, output and print inspection results of a connected vehicle diagnostic electronic device 90. The module expansion slot 30 is arranged on the second board 102 of the shell 10 and is connected with the vehicle diagnostic electronic device 90 in a snap-fit manner so as to fix relative positions of the vehicle diagnostic electronic device 90 and the shell 10. The first signal part is connected with a second signal, part of the vehicle diagnostic electronic device 90 so as to achieve communication between the main board and the vehicle diagnostic electronic device 90 to achieve an inspection function, an inspection result output function and the like. It should be noted that the module expansion slot 30 can also be arranged on the first side 103 of the shell 10. It should be noted that the module expansion slot 30 can also be arranged on the second side 104 of the shell 10.

In embodiments, special vehicle diagnostic electronic devices 90 are designed to be conveniently mounted on the modular tablet computer. By changing the different functions of vehicle diagnostic electronic devices 90 installed on the modular tablet computer, inspection functions and an inspection result output function required by vehicle inspection can be achieved; therefore, connection flows for achieving different inspection functions are simplified, and multiple inspection functions can be achieved without the need of connecting different modular tablet computer for the vehicle diagnostic electronic device 90 can directly utilize a main board of the existing tablet computer. The functions of the vehicle diagnostic electronic device 90 are relatively mature in the prior, correspondingly only the size of the vehicle diagnostic electronic device 90 needs to be designed with reference to the modular tablet computer of the vehicle diagnostic electronic device 90; therefore, such size can be minimized, and, then the whole size of the vehicle diagnostic electronic device 90 and its modular tablet computer can also be minimized; at this time, the whole vehicle diagnostic electronic device 90 and its modular tablet computer are convenient to carry.

In an embodiment, the display screen 20 may be a touch screen, on which some control signals can be inputted to control display information, inspection process and the like of the modular tablet computer of the vehicle diagnostic electronic device 90.

Optionally, the first signal part is a communication interface 305. The communication interface 305 is electrically connected with the main board and is arranged on the module expansion slot 30. When the module expansion slot 30 is connected with the vehicle diagnostic electronic device 90 in the snap-fit manner, the main board and the vehicle diagnostic electronic device 90 are connected through the communication interface 305 so as to be communicated to achieve the inspection functions and the inspection result output function.

In an embodiment, as shown in FIG. 2, the modular tablet computer further comprises multiple mounting holes arranged on the module expansion slot 30. The mounting holes may be arranged on an opposite third side 301 and a fourth side 302, as well as an opposite fifth side 303 and a sixth side 304, which are formed when the module expansion slot 30 is sunken in the second board 102 of the shell 10. Or the mounting holes may be arranged on a sunken portion of the second board 102. When the vehicle diagnostic electronic device 90 is arranged on the modular tablet computer in the snap-fit manner, the mounting holes can lock the vehicle diagnostic electronic device 90 so as to prevent the vehicle diagnostic electronic device 90 from sliding and improve relative stability of the vehicle diagnostic electronic device 90 and its modular tablet computer.

In an embodiment, there are four mounting holes, namely a first mounting hole, second mounting hole, a third mounting hole and a fourth mounting hole. An opposite third side 301 and a fourth side 302 as, well as an opposite fifth side 303 and a sixth side 304 are formed when the module expansion slot 30 is sunken in the second board 102 of the shell 10. The first mounting hole and the second mounting hole are respectively arranged on the third side 301 and the fourth side 302 so as to reduce two degrees of freedom in vertical directions of the third side 301 and the fourth side 302 after an external module is in snap fit with the modular tablet computer. The third mounting hole and the fourth mounting hole are arranged on the fifth side 303 so as to reduce a degree of freedom in a vertical direction of the fifth side 303 after the vehicle diagnostic electronic device 90 is connected with the modular tablet computer in the snap-fit manner. Therefore, the vehicle diagnostic electronic device 90 can be greatly fixed by utilizing a few mounting holes.

In an embodiment, the first mounting hole and the second mounting hole are movable mounting holes while the third mounting hole and the fourth mounting hole are fixed mounting holes. When the vehicle diagnostic electronic device 90 is mounted, as shown in FIG. 5, a first fixed snap-fit joint 904, a second fixed snap-fit joint 905, a first movable snap-fit joint 902 and a second movable snap-fit joint 903 of the vehicle diagnostic electronic device 90 are respectively sequentially inserted into the third mounting hole, the fourth mounting hole the first mounting hole and the second mounting hole.

In an embodiment, the modular tablet computer of the vehicle diagnostic electronic device 90 further comprises a first slide rail passing through the first mounting hole and a second slide rail passing through the second mounting hole. The opposite third side 301 and the fourth side 302 are formed when the module expansion slot 30 is sunken in the second board 102 of the shell 10. The first slide rail is located on the third side 301 and is parallel with the second board 102, and the second slide rail is located on the fourth side 302 and is parallel with the second board 102. At this time, the first movable snap-fit joint 902 of the vehicle diagnostic electronic device 90 slides on the first slide rail and is pressed into a first telescoping hole, next it pops up when passing through the first mounting hole and finally is locked in the first mounting hole. The second movable snap-fit joint 903 of the vehicle diagnostic electronic device 90 slides on the second slide rail and is pressed into a second telescoping hole, next, it pops up when passing through the second mounting hole and finally is locked in the second mounting hole. Therefore, the mounting of the vehicle diagnostic electronic device 90 is facilitated, and the positions of the vehicle diagnostic electronic device 90 in vertical directions of the boards are also limited, that is, two degrees of freedom are reduced.

In an embodiment, the modular tablet computer of the vehicle diagnostic electronic device 90 further comprises a third slide rail and a fourth slide rail. The opposite third side 301 and the fourth side 302 are formed when the module expansion slot 30 is sunken in the second board 102 of the shell 10. The third slide rail is located on the third side 301 and is vertical to the second board 102, and the fourth slide rail is located on the fourth side 302 and is vertical to the second board 102. At this time, the first movable snap-fit joint 902 of the vehicle diagnostic electronic device 90 slides on the third slide rail and is pressed into a first telescoping hole, next it pops up when passing through the first mounting hole and finally is locked in the first mounting hole. The second movable snap-fit joint 903 of the vehicle diagnostic electronic device 90 slides on the third slide rail and is pressed into a second telescoping hole, next it pops up when passing through the second mounting hole and finally is locked in the second mounting hole. Therefore, the mounting of the vehicle diagnostic electronic device 90 is facilitated, and the positions of the vehicle diagnostic electronic device 90 in parallel directions of the third side 301 are also limited, that is, two degrees of freedom are reduced.

In an embodiment, as shown in FIG. 2 and FIG. 3, the modular tablet, computer further comprises an aviation plug female connector 60, which is arranged at a handheld end 50 on the first side 103 and is used for connecting an aviation plug male connector of an extension line.

It should be understood that one end of the extension line is the aviation plug male connector and is, connected with the aviation plug female connector 60 of the modular tablet computer while the other end thereof is an on-board diagnostics (OBD) standard interface and is interconnected with an OBD standard interface of an automobile. Therefore, through the OBD standard interface of the automobile, driving data, vehicle condition data and the like of the automobile are transmitted to the modular tablet computer; at this time, the maintenance person can conveniently check out the automobile data anytime.

Furthermore, the aviation plug female connector 60 can further be directly connected with an aviation plug male connector of an endoscope produced by THINKCAR TECH CO., LTD. such that the vehicle data can be detected through the endoscope.

In an embodiment, to help a user to hold the modular tablet computer, the shell 10 further comprises a handheld end 50. The handheld end 50 is mounted on the second board 102 of the shell 10 and is adjacent to the module expansion slot 30 on the second board 102. Therefore, when holding the modular tablet computer by hands, the user still can immediately confirm whether the vehicle diagnostic electronic device 90 is connected with the modular tablet computer.

In an embodiment, as shown in FIG. 2 and FIG. 3, the modular tablet computer further comprises a button module, a power button 70, a camera button 80 and a camera 40, all of which are mounted on the shell 10.

The power button 70 is used for turning on the modular tablet computer of the vehicle diagnostic electronic device 90. The camera button 80 is used for turning on a camera of the modular tablet computer of the vehicle diagnostic electronic device 90. The camera 40 is used for achieving a photographing function of the modular tablet computer of the vehicle diagnostic electronic device 90. The button module is electrically connected with the main board and is used for inputting control signals to control the vehicle diagnostic electronic device 90 and control the display screen 20 to display the diagnostic content, such as turning on an infrared imaging function, controlling imaging size and the like. It should be noted that the button module can utilize the existing button circuit, and its button input functions are configured through the main board.

Furthermore, the first signal part of the modular tablet computer and the second signal part of the vehicle diagnostic electronic device 90 further may be wireless network modules to achieve wireless communication between the modular tablet computer and the vehicle diagnostic electronic device 90, reduce connecting lines thereof and improve convenience. It should be understood that the wireless network module may be Bluetooth module, NEC module and the like, which is configured according to actual situation and is not limited herein.

In an embodiment, when the module expansion slot 30 is arranged on one side of the modular tablet computer, an expanded vehicle diagnostic electronic device can be clamped and fixed to the side through a clamping part arranged on the side. The first signal part of the modular tablet computer is communicated with the second signal part of the vehicle diagnostic electronic device such that the modular tablet computer and the vehicle diagnostic electronic device are matched in use and convenience during vehicle diagnostic is improved.

To solve problems provided by the present invention, as shown in FIG. 1 and FIG. 5, the present invention further provides a vehicle diagnostic electronic system. The vehicle diagnostic electronic system comprises at least one vehicle diagnostic electronic device 90 and the above-mentioned modular tablet computer of the vehicle diagnostic electronic device 90. The vehicle diagnostic electronic device 90 is mounted on the shell 10 of the modular tablet computer which can be connected with the vehicle diagnostic electronic device 90 in a snap-fit manner. Additionally, the first signal part of the modular tablet computer can be communicated with the second signal part of the vehicle diagnostic electronic device 90.

In the embodiments, special vehicle diagnostic electronic devices 90 are designed to be conveniently mounted on the modular tablet computer. Corresponding functions can be achieved only by signal transmission lines. By changing the different functions of vehicle diagnostic electronic devices 90 mounted on the modular tablet computer, inspection functions and an inspection result output function required by vehicle inspection can be achieved; therefore, connection flows for achieving different inspection functions are simplified, and multiple inspection functions can be achieved without the need of connecting different devices through multiple connecting lines in the prior art. Furthermore, the main board of the modular tablet computer for the vehicle diagnostic electronic device 90 can directly utilize a main board of the existing tablet computer. The functions of the vehicle diagnostic electronic device 90 are relatively mature in the prior, correspondingly only the size of the vehicle diagnostic electronic device 90 needs to be designed with reference to the modular tablet computer of the vehicle diagnostic electronic device 90; therefore, such size can be minimized, and then the whole size of the vehicle diagnostic electronic device 90 and its modular tablet computer can also be minimized; at this time, the whole vehicle diagnostic electronic device 90 and its modular tablet computer are convenient to carry.

In an embodiment, as shown in FIG. 6 and FIG. 8, the vehicle diagnostic electronic device 90 comprises a first movable snap-fit joint 902, a second movable snap-fit joint 903, a snap-fit joint button 906 as well as an opposite first side face and a second side face. The snap-fit joint button 906 is mounted on the vehicle diagnostic electronic device 90. The first telescoping hole for mounting the first movable snap-fit joint 902 is formed in the first side face of the vehicle diagnostic electronic device 90. The second telescoping hole for mounting the second movable snap-fit joint 903 is formed in the second side face of the vehicle diagnostic electronic device 90.

At this time, a movable snap-fit, joint circuit is additionally provided as required. The movable, snap-fit joint circuit is an electromagnetic switching circuit. When the vehicle diagnostic electronic device 90 needs to be externally connected with the modular tablet computer, first, the first fixed snap-fit joint 904 and the second fixed snap-fit joint 905 are respectively placed in the third mounting hole and the fourth mounting hole of the module expansion slot 30; second, the snap-fit joint button 906 is pressed down such that electromagnets in the electromagnetic switching circuit are powered on; under the magnetic function of the electromagnets, movable snap-fit joints 13 move to the interior of the vehicle diagnostic electronic device 90; at this time, the vehicle diagnostic electronic device 90 is pressed into the module expansion slot 30; third, the snap-fit joint button 906 is pressed down again such that the electromagnets are powered off; the magnetic function of the electromagnets are disappeared, so the first movable snap-fit joint 902 and the second movable snap-fit joint 903 extend under the elastic function of a spring at the bottom of the snap-fit joint button so to be respectively in snap-fit with the first mounting hole and the second mounting hole of the module expansion slot 30. When the vehicle diagnostic electronic device 90 needs to be detached from the modular tablet computer, the snap-fit joint button 906 is pressed by the hand such that the first movable snap-fit joint 902 and the second movable snap-fit joint 903 are disconnected with the first mounting hole and the second mounting hole, of the module, expansion slot 30, and then the vehicle diagnostic electronic device 90 can be taken out. It should be noted that the electromagnetic switching circuit may utilize an electromagnetic switching circuit in the prior art as long as it has an electromagnetic attraction function.

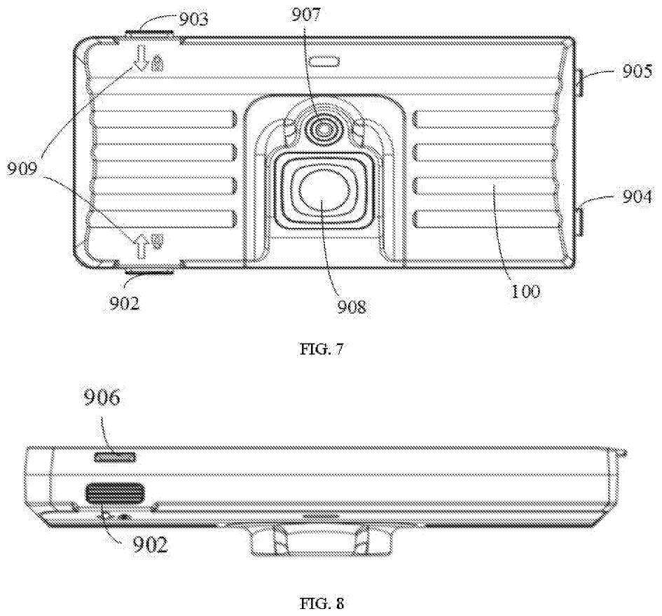

When the vehicle diagnostic electronic device 90 is mounted, as shown in FIG. 7, a first fixed snap-fit joint 904, a second fixed snap-fit joint 905, a first movable snap-fit joint 902 and a second movable snap-fit joint 903 of the vehicle diagnostic electronic device 90 are respectively sequentially inserted into the third mounting hole, the fourth mounting, hole, the first mounting hole and the second mounting hole. The first telescoping hole is used for allowing pressing of the first movable snap-fit joint, and the second telescoping hole is used for allowing pressing of the second movable snap-fit joint such, that the second side face forms a flat surface to facilitate mounting and sliding.

In an embodiment, the vehicle diagnostic electronic device 90 further comprises a first fixed snap-fit joint 904, a second fixed snap-fit joint 905 and a third side face vertical to the first side face and the second side face. The first fixed snap-fit joint 904 and the second fixed snap-fit joint 905 are arranged on the third side face. When the vehicle diagnostic electronic device 90 is connected with the shell 10 in the snap-fit manner, the first fixed snap-fit joint 904 and the second fixed snap-fit joint 905 are respectively in snap fit with the third mounting hole and the fourth mounting hole of the modular tablet computer of the vehicle diagnostic electronic device 90. Therefore, one degree of freedom of the vehicle diagnostic electronic device 90 in snap-fit is reduced.

In an embodiment, as shown in FIG. 7, the vehicle diagnostic electronic device 90 comprises an opposite mounting side face and a nonslip side face. The mounting side face is close to the module expansion slot 30 of the modular tablet computer of the vehicle diagnostic electronic device 90 when such module expansion slot is connected with the vehicle, diagnostic electronic device 90 in the snap-fit manner. The nonslip side face is further provided with nonslip lines 100 and snap-fit direction indication arrows 909. The nonslip lines 100 can be used for increasing the friction force when the vehicle diagnostic electronic device 90 is taken out so as to improve the safety in use. The direction indication arrows 909 are used for indicating the directions when the movable snap-fit joints are pressed down.

In an embodiment, the vehicle diagnostic electronic device 90 is any element selected from a group including a thermographic instrument, a lamp panel, a printer, an oscilloscope, an endoscope, a battery tester, a sensor tester and a projector. It should be noted that, the specific vehicle inspection equipment, such as the printer, the lamp panel, the projector, the oscilloscope, the battery tester, the sensor tester and the like, is designed according to an interface of a mounting position 12 of the modular tablet computer such that the vehicle diagnostic electronic device 90 and the modular tablet computer are matched in use. The printer can further be additionally provided with a signal transmission line. When the vehicle diagnostic electronic device 90 is the thermographic instrument, the oscilloscope, the endoscope, the battery tester, the sensor tester or the projector, it conducts signal exchange through, a signal interface. When the vehicle diagnostic electronic device 90 is the lamp panel or the printer, it conducts the signal exchange by adding the signal transmission line. In an embodiment, the vehicle diagnostic electronic device 90 further comprises a communication interface 305. When the vehicle diagnostic electronic device 90 is the thermographic instrument, the thermographic instrument is square-shaped. The thermographic instrument is provided with a thermal imaging camera 907/908. The thermal imaging camera 907/908 and the communication interface 305 are located on two reverse surfaces. Wherein the vehicle diagnostic electronic device 90 may be a special thermographic instrument, a printer, a working lamp, a projector, an oscilloscope, a battery tester or a sensor tester produced by Shenzhen Xingka Technologies Limited Company, which is not limited herein.

Therefore, the following detailed description of the embodiments of the present invention in the accompanying drawings is not intended to limit the protection scope of the present invention, but merely represent selected embodiments of the present invention. All other embodiments obtained by those of ordinary skill in the art based on the embodiments of the present invention without creative efforts shall fall within the protection scope of the present invention.

What is claimed is:

1. A modular tablet computer, comprising:
a shell, having an opposite first board and a second board, as well as an opposite first side and a second side;
a display screen, located on the first board of the shell and connected with the shell in a snap-fit manner;
a module expansion slot, arranged on the second board, the first side or the second side of the shell and connected with a vehicle diagnostic electronic device, in the snap-fit manner;
a main board, electrically connected with the display screen and arranged in the shell; and
a first signal part, connected with a second signal part of the vehicle diagnostic electronic device.

2. The modular tablet computer according to claim 1, wherein the first signal part is a communication interface, is electrically connected with the main board and is arranged on the module expansion slot; when the module expansion slot is connected with the vehicle diagnostic electronic device in the snap-fit manner, the main board and a communication interface of the vehicle diagnostic electronic device are connected through the communication interface.

3. The modular tablet computer according to claim 1, further comprising multiple mounting holes, which are arranged on the module expansion slot.

4. The modular tablet computer according to claim 3, wherein there are four mounting holes, namely a first mounting hole, a second mounting hole, a third mounting hole and a fourth mounting hole; an opposite third side and a fourth side as well as an opposite fifth side and a sixth side are formed when the module expansion slot is sunken in the second board of the shell; the first mounting hole and the second mounting hole, are respectively arranged on the third side and the fourth side; the third mounting hole and the fourth mounting hole are arranged on the fifth side.

5. The modular tablet computer according to claim 4, wherein the first mounting hole and the second mounting hole are movable mounting holes while the third mounting hole and the fourth mounting hole are fixed mounting holes.

6. The modular tablet computer according to claim 5, further comprising a first slide rail passing through the first mounting hole and a second slide rail passing through the second mounting hole, wherein the opposite third side and the fourth side are formed when the module expansion slot is sunken in the second board of the shell; the first slide rail is located on the third side and is parallel with the second board, and the second slide rail is located on the fourth side and is parallel with the second board.

7. The modular tablet computer according to claim 5, further comprising a third slide rail and a fourth slide rail, wherein the opposite third side and the fourth side are formed when the module expansion slot is sunken in the second board of the shell; the third slide rail is located on the third side and is vertical to the second board, and the fourth slide rail is located on the fourth side and is vertical to the second board.

8. The modular tablet computer according to claim 1, further comprising an aviation plug female connector, which is arranged at a handheld end on the first side and is used for connecting an aviation plug male connector of an extension line.

9. The modular tablet computer according to claim 1, wherein the shell further comprises the handheld end, which is mounted on the second board of the shell and is adjacent to the module expansion slot on the second board.

10. The modular tablet computer according to claim 1, further comprising a button module, a power button, a camera button and a camera, all of which are mounted on the shell, wherein
the button module is electrically connected with the main board and is used for inputting control signals to control the vehicle diagnostic electronic device and control the display screen to display the diagnostic content.

11. A vehicle diagnostic electronic system, wherein the vehicle diagnostic electronic system comprises at least one vehicle diagnostic electronic device, a signal transmission line and a modular tablet computer; the vehicle diagnostic electronic device is mounted on the shell of the modular tablet computer in a snap-fit manner; the first signal part of the modular tablet computer is communicated with the second signal part of the vehicle diagnostic electronic device.

12. The vehicle diagnostic electronic system according to claim 11, wherein the vehicle diagnostic electronic device comprises a first movable snap-fit joint, a second movable snap-fit joint, a snap-fit joint button as well as an opposite first side face and a second side face; the snap-fit joint button is mounted on the vehicle, diagnostic electronic device; a first telescoping hole for mounting the first movable snap-fit joint is formed in the first side face; a second telescoping hole for mounting the second movable snap-fit joint is fainted in the second side face.

13. The vehicle diagnostic electronic system according to claim 12, wherein the vehicle diagnostic electronic device further comprises a first fixed snap-fit joint, a second fixed snap-fit joint and a third side face vertical to the first side face and the second side face; the first fixed snap-fit joint and the second fixed snap-fit joint are arranged on, the third side face; when, the vehicle diagnostic electronic device is connected with the shell in the snap-fit manner, the first fixed snap-fit joint and the second fixed snap-fit joint are respectively in snap fit with the third mounting hole and the fourth mounting hole of the modular tablet computer.

14. The vehicle diagnostic electronic system according to claim 12, wherein the vehicle diagnostic electronic device comprises an opposite mounting side face and a nonslip side face; the mounting side face is close to the module expansion slot of the modular tablet computer when the module expansion slot of the modular tablet computer is connected with the vehicle diagnostic electronic device in the snap-fit manner; the nonslip side face is further provided with nonslip lines and snap-fit direction indication arrows.

15. The vehicle diagnostic electronic system according to claim 11, wherein the vehicle diagnostic electronic device is any element selected from a group including a thermographic instrument, a lamp panel, a printer, an oscilloscope, an endoscope, a battery tester, a sensor tester and a projector.

16. The vehicle diagnostic electronic system according to claim 14, wherein the vehicle diagnostic electronic device further comprises a communication interface; when the vehicle diagnostic electronic device is the thermographic instrument, the thermographic instrument is square-shaped; the thermographic instrument is provided with a thermal imaging camera; the thermal imaging camera and the communication interface are located on two reverse surfaces.
